(19) United States
(12) Patent Application Publication
(10) Pub. No.: US 2011/0262606 A1
(43) Pub. Date: Oct. 27, 2011

(54) METHOD FOR PRODUCING MILK FOAM

(75) Inventors: Mathilde Blondel, Saint Germain La Blance Herbe (FR); Gilles Morin, Sainte Honorine de Fay (FR); Lionnel Durand, Saint Germain Langot (FR); Peter Ireman, Ver Sur Mer (FR); Patrick Deliens, Mayenne (FR)

(73) Assignee: SEB SA, Ecully (FR)

(21) Appl. No.: 12/937,932

(22) PCT Filed: Apr. 10, 2009
(86) PCT No.: PCT/FR09/50675

§ 371 Date: Feb. 8, 2011

(30) Foreign Application Priority Data
Apr. 15, 2008 (FR) 0852501

(51) Int. Cl. A23P 1/16; A23C 9/00

(52) U.S. Cl. 426/474

(57) ABSTRACT

A milk-foaming method including a preliminary preheating step during which milk is heated to a foam start production temperature between 30 and 40° C., and a foaming step during which air is added to said preheated milk such as to produce milk foam.

### BACKGROUND OF THE INVENTION

The present invention relates to a method for producing milk foam, particularly in order to produce among others coffee and chocolate based drinks, such as cappuccinos or macchiatos.

Is already known, a method for producing foam during which air is added into milk in order to obtain foam. However, it turns out that the quality of foam, that is, its expansion or its resistance in time, depends on several factors: its temperature (from about 5° C. when taken out of the fridge to about 20° C. at room temperature), its fat content (whole milk, semi-skimmed or skimmed), and the treatment undergone by milk for its preservation (pasteurized or UHT milk).

The aim of the invention is to obtain, whatever the type of milk and the temperature before its preparation, milk foam whereof the quality is under control so that it corresponds to the expected drink.

### SUMMARY OF THE INVENTION

According to the invention, the foaming method includes, prior to the foam production step during which air is added into milk such as to produce foam, a heating step during which milk is heated to a foam production start temperature between 25° C. and 40° C., and preferably, between 30° C. and 40° C. It is also possible to get a foam production start temperature between 25° C. and 32° C., or preferably, between 25° C. and 30° C.

In fact, it has turned out after a study carried out on the capacity of milk to produce foam and on its stability, that the fat globules contained in milk are of a more or less solid form until about a temperature of 30° C. where they are in liquid phase, a phase wherein their anti-foam action disappears (or, at least, is highly reduced).

Thus, the fact of heating milk to at least 25° C. and preferably, to at least 30° C. before adding the air to produce the milk foam, allows the production of a good quality foam, and thus whether the milk is whole milk, half-skimmed or skimmed, pasteurized or UHT.

Other details and advantages of this invention will appear in the description of three non-limitative embodiments given by way of examples and illustrated in the drawings in the appendix, in which:

### BRIEF DESCRIPTION OF THE DRAWINGS

FIG. 1 is a schematic view of a first device used to implement the foam production method according to the present invention, the step in progress being the preheating one;

FIG. 2 is a schematic view of the first device, the step in progress being the foam production one;

FIG. 3 is a cross-sectional view of the first device;

FIG. 4 is a schematic view of a second device used to implement the foam production method according to the present invention, the step in progress being the preheating one;

FIG. 5 is a schematic view of the second device, the step in progress being the foam production one;

FIG. 6 is a schematic view of a third device used to implement the foaming method according to the present invention, the step in progress being the preheating one; and

FIG. 7 is a schematic view of the third device, the step in progress being the foaming one.

### DETAILED DESCRIPTION

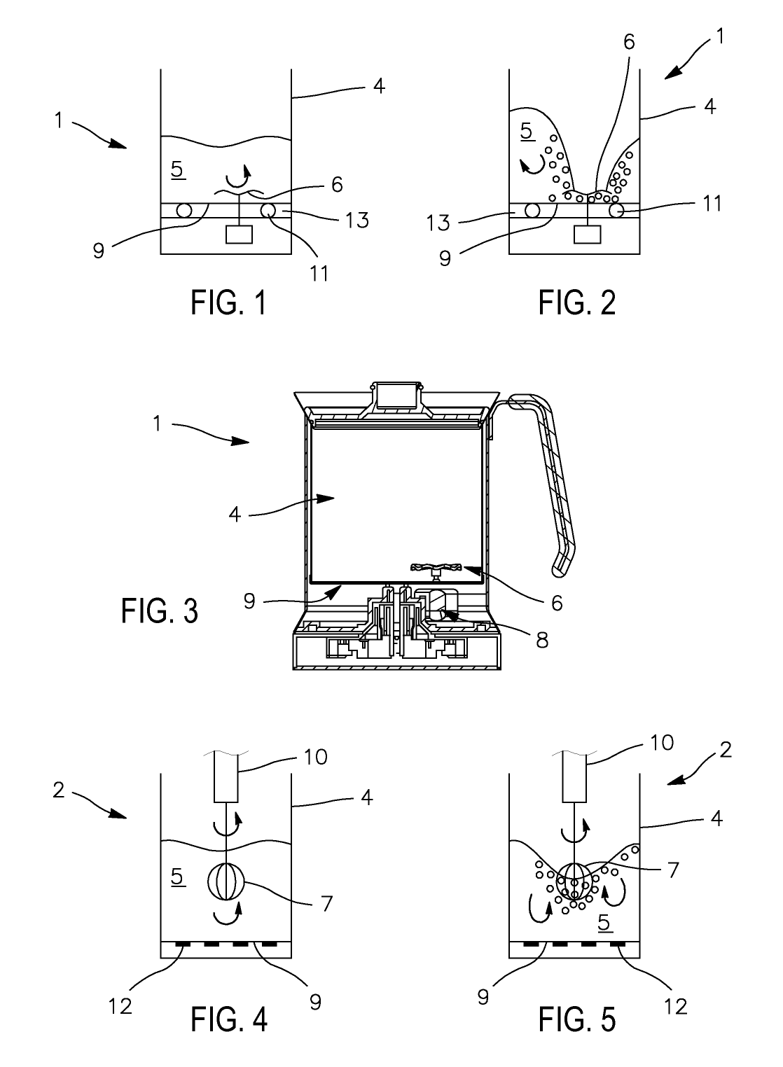

The different foaming devices 1, 2, 3 illustrated in FIGS. 1 to 7 are used to produce milk foam, this being intended for the preparation of a drink, for example coffee-based or chocolate-based.

According to the invention, the method for producing milk foam includes a preliminary heating step during which the milk is heated up to a foam production start temperature between 25 and 60° C., and preferably between 30 and 40° C., followed by a foaming step during which the air is added into the milk such as to produce milk foam.

Thus, the air is added into the milk in sufficient quantity to produce foam only when the milk has reached a foam production start temperature at least equal to 25° C. This temperature may vary, particularly depending on the recipe of the drink to be prepared, the temperature of 35° C. being moreover the optimal temperature for the making and the stability of the milk foam.

In order to improve the heating of milk during the preheating step, it is preferable to stir the milk. This stirring is not intended to produce the foam and thus it is insufficient to allow an incorporation of air. Its aim is to homogenize the milk temperature. Finally, it may be necessary to continue the heating of milk during the foam production step so that the milk (or more precisely the milk foam) reaches a foam end production temperature higher than the foam start production temperature, corresponding to the temperature of the prepared drink according to the recipe in progress (for example 70° C.).

FIGS. 1 to 5 illustrate two foaming devices 1, 2, each comprising a container 4 wherein milk is poured 5, and a mechanical tool 6, 7, whereof the movement in the milk, produces foam. Thus, according to these devices 1, 2, during the foam production step, the incorporation of air is achieved by the movement of the mechanical tool 6, 7 at a foaming speed and, in these two embodiments, by its rotation. At the foaming speed, the mixing of milk is so important that the surrounding air is added to the milk, thus producing the foam.

In the embodiment illustrated by FIGS. 1 to 3, the mechanical tool 6 (in this case, a wavy disk 6) is mounted on the bottom of the container 4, and, in this embodiment, its axis of rotation is shifted from the bottom center in order to facilitate the foam production. The disk 6 is driven into rotation by means of an electric motor 8 arranged under the container bottom wall 9.

By way of example, the disk 6 can have a diameter between 25 and 35 mm, and preferably, in the order of 31 mm, and comprising between 4 and 8 undulations extending radially. The depth of these undulations can be between 2 and 6 mm, and preferably in the order of 4 mm.

In the embodiment illustrated by FIGS. 4 and 5, the mechanical tool 7 is carried by a moveable member 10 plunging into the container 4. This moveable member 10 is of the same type as an “Egg whisk” or “Hand Blender”.

By way of example, the mechanical tool 7 has a general shape of a sphere 7 having a diameter between 20 and 50 mm. It is made of wires (preferably between 8 and 12) in an arc shape. These wires, in stainless steel for example, may have a diameter between 0.5 and 1 mm, preferably in the order of 0.9 mm.

In these two embodiments, an electrical resistive element 11, 12 is mounted at the bottom wall 9 of container 4, allowing heating the milk. In view of the device 1, 2 usage, the heating power can range from 400 to 700W, and preferably in the order of 600W. In the first embodiment, the resistive element 11 is a shielded resistor 11 bound to an aluminum distribution block 13. In the second embodiment, the resistive element 12 is made of a resistor 12 screen-printed on the outer side of the stainless steel bottom wall 9, allowing to have a very high precision in the thermal regulation because of the low inertia of this heating mode (in FIGS. 4 and 5, the screen-printed resistance is represented in an exaggerated manner).

More precisely, with a device 1 in accordance with the first embodiment, in order to add an important quantity of air in the milk 5, during the foam production step, the tool 6 foaming speed is higher than 2500 rpm, and preferably higher than 3000 rpm.

Moreover, according to the recipes, and hence according to the expansion rate of required foam (that is to say according to the foam consistency), during the foam production step, the rotational speed of the tool 6, 7 can be either constantly at least equal to the foaming speed, or intermittently. In this last case, the tool 6, 7 alternatively goes through at least a foaming step during which its rotational speed is constantly equal at least to the foaming speed, and at least through a mixing step during which its rotational speed is equal to a mixing speed inferior to the foaming speed. The foaming speed is, preferably, at the most equal to two thirds of the foaming speed.

More precisely, with a device 1 in accordance to the first embodiment, the mixing speed is constantly inferior to 2000 rpm, preferably inferior to 1500 rpm, and even inferior to 1000 rpm.

Besides, the start and/or the end of a foam production step may be determined, for example, either by a time count, or by the measurement of milk temperature (when the milk is heated during the foam production step). When determining the end of a step by means of time count, this count is initialized at the beginning of said cycle. Thus, the duration of a foaming step can be determined by a duration (for example 8 seconds) or by a temperature increase (for example 5° C.).

Moreover, the tool's 6, 7 foaming speed may be constant or may vary in accordance with a computer program. The same applies to the mixing speed. Further, when the foam production step comprises many foaming phases and/or many mixing phases, the foaming and/or mixing speeds can be either identical or specific to each step.

In addition, the tool 6, 7 foaming speed can be determined according to the volume of the milk to be foamed (from the volume of milk in the container 4). This volume can be particularly estimated by the measurement of the speed of temperature increase of milk during the preheating step. The same applies to the mixing speed.

Moreover, during the preheating step, the milk 5 is preferably stirred by the moving of the tool 6, 7 to improve the heating via homogenization. The tool rotational stirring speed is sufficiently low to prevent adding air that leads to foaming. Preferably, this stirring speed is at most equal to the two thirds of the foaming speed.

Thus, in the first embodiment, the stirring speed is at most equal to 1500 rpm, and preferably, at most equal to 1000 rpm.

Like the foaming and mixing speeds, the stirring speed can be constant. It can also be determined according to the volume of the milk to be foamed (possibly in accordance to the speed of temperature increase of milk).

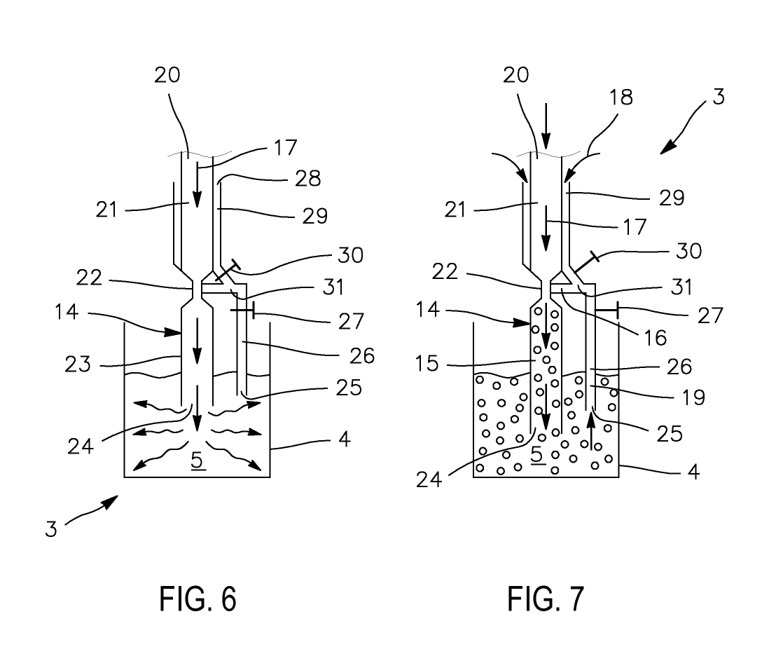

FIGS. 6 and 7 illustrate a third foaming device 3 that comprises a container 4 wherein milk 5 is poured, and an injection nozzle 14 used to produce foam. Thus, according to this device 3, during the foam production step, the incorporation of air is achieved by using the injection nozzle 14.

More precisely, the injected air is part of a mixture of air, milk and steam 15 produced during the suction of a mixture of air and milk 16 by means of a flow of dry steam 17 produced by the device 3. The mixture of air and milk 16 is itself produced during the suction of the external air 18 by means of a milk flow 19 from the preheated milk.

Thus, the injection nozzle 14 comprises a steam inlet port 20 whereby the steam is introduced into the nozzle 14, this port 20 being at the upstream end of a steam supply duct 21 exhibiting a venturi 22 that extends beyond the latter via an injection duct 23 whereof the downstream end is formed by an output port 24. The injection nozzle 14 also comprises a milk inlet port 25, this port 25 being at the upstream end of a milk supply duct 26 that extends parallel to the injection duct 23, which comprises a valve 27 that opens into the venturi 22. Finally, the injection nozzle 14 comprises an air inlet port 28, this port 28 being at the upstream end of an air supply duct 29 which is, in the present embodiment, an annular duct in the center of which is the steam supply duct 21, comprising a valve 30 and which opens (in 31) into the milk supply duct 26. The arrangement of the air supply duct with respect to the steam supply duct allows the steam 17 to reheat the air before it mixes with the milk, in order to improve the stability of the foam.

Thus, during the foam production step, the steam produced by the device 3 circulates along the steam supply duct 21 then through the injection duct 23 while passing through the venturi 22. The negative pressure draws up the air/milk mixture, the air coming from the outside via the air supply duct 29, and the milk coming from the container 4 via the milk supply duct 26.

Moreover, this foaming device 3 allows, during the preheating step, to heat the milk by the injection of a flow of dry water steam 17 by means of a steam injection nozzle which is, in this case, the nozzle 6 used for the injection of air during the foam production step. The use of dry steam allows, thanks to its latent heat, to provide a large amount of energy to the milk to be heated. During the preheating step, the valve 30 of the air supply duct 29 is closed in order to prevent foam production. Moreover, it is preferable that the valve 27 of the milk supply duct 26 be open in order to improve the stirring of milk and the homogeneity of its temperature.

The present invention is not limited to the embodiments given by way of examples. Thus, it will be possible to use a device comprising two different nozzles, one for the preheating, and the other for the foaming. It will also be possible to have one-nozzle (or a two-nozzle) foaming device as well as a base-heating container and/or a mechanical tool.

What is claimed is:

1. A milk-foaming method comprising a preliminary preheating step during which milk is heated to a foam start production temperature between 30 and 40° C., and a foaming step during which air is added to said preheated milk such as to produce milk foam.

2. The milk-foaming method according to claim 1, wherein during the preheating step, the milk is stirred.

3. The milk-foaming method according to claim 1 wherein during the foaming step, the milk is heated to a temperature higher than the foam start production temperature.

4. The milk-foaming method according to claim 1 wherein during the foaming step, air is added by moving a mechanical tool at a foaming speed.

5. The milk-foaming method according to claim 4, wherein during the foaming step, the tool speed is constantly at least equal to the foaming speed.

6. The milk-foaming method according to claim 5, wherein during the foaming step, the tool alternatively passes through at least one foaming step during which the tool speed is at least constantly equal to the foaming speed, and at least one mixing step during which the tool reaches a stirring speed inferior to the two thirds of the foaming speed.

7. The milk-foaming method according to claim 6, wherein the duration of the foaming step is determined from a time count.

8. The milk-foaming method according to claim 6, wherein the duration of the foaming step is determined from a measurement of the milk temperature.

9. The milk-foaming method according to claim 6 wherein the tool stirring speed is constant.

10. The milk-foaming method according to claim 6, wherein the tool stirring speed is determined according to the volume of the milk to be foamed.

11. The milk-foaming method according to claim 4 wherein the tool foaming speed is constant.

12. The milk-foaming method according to claim 4 wherein the tool foaming speed is determined according to the volume of the milk to be foamed.

13. The milk-foaming method according to claim 4 wherein during the preheating step, the milk is stirred by a movement of the tool at a stirring speed inferior to the two-thirds of the foaming speed.

14. The milk-foaming method according to claim 13, wherein the tool stirring speed is constant.

15. The Milk-foaming method according to claim 13 the tool stirring speed is determined according to the volume of the milk to be foamed.

16. The milk-foaming method according to claim 1 wherein during the foaming step, air is added by means of an injection nozzle.

17. The milk-foaming method according to claim 16, wherein the injected air is part of air and milk mixture produced during a drawing up of outside air by a milk flow coming from the pre-heated milk.

18. The milk-foaming method according to claim 17, wherein the injected air results from a mixture of air, milk and steam created during a drawing up, by a flow of dry water steam, of air and milk mixture.

19. The milk-foaming method according to claim 1 wherein, during the preheating step, preheating of milk is achieved by injecting within milk a flow of dry water steam by means of an injection nozzle.

20. The milk-foaming method according to claim 19, wherein, during the preheating step, the injected steam is part of a mixture of steam and milk created during a drawing up, by a flow of dry water steam, of the milk contained in a container wherein the injection nozzle opens into.
